(19) United States
(12) Patent Application Publication
(10) Pub. No.: US 2025/0147195 A1
(43) Pub. Date: May 8, 2025

(54) X-RAY MEASUREMENT SYSTEM WITH HIGH SIGNAL RESOLUTION

(71) Applicant: NanoSeex Inc., Hsinchu County (TW)

(72) Inventors: YU-YAN AU YONG, Hsinchu County (TW); TSUNG-HSIEN HAN, Hsinchu County (TW); CHUN-TING LIU, Hsinchu County (TW); PO-CHING HE, Hsinchu County (TW); PO-TSANG WU, Hsinchu County (TW)

(21) Appl. No.: 18/929,644

(22) Filed: Oct. 29, 2024

Related U.S. Application Data
(60) Provisional application No. 63/595,342, filed on Nov. 2, 2023.

(30) Foreign Application Priority Data
Oct. 11, 2024 (TW) 113138590

(51) Int. Cl. G01T 1/24; G01T 1/20

(52) U.S. Cl. CPC G01T 1/241; G01T 1/2018; G01T 1/244

(57) ABSTRACT

An X-ray measurement system with high signal resolution is provided. The X-ray measurement system includes an X-ray generator, an X-ray optical element group, a multi-dimensional X-ray detector and a processing device. The X-ray generator is configured to generate an incident X-ray beam. X-ray optics are used to guide the incident X-ray beam to a to-be-tested sample. The multi-dimensional X-ray detector is used to receive the measurement X-ray generated by irradiating the incident X-ray beam on the to-be-tested sample. The multi-dimensional X-ray detector includes an insulation layer, a plurality of first electrode layers, a photodiode layer, an X-ray conversion material layer made of amorphous selenium, and a second electrode layer. The processing device is configured to collect a to-be-tested X-ray signal and generate a plurality of measurement results that include a plurality of mode signals of different orders.

### CROSS-REFERENCE TO RELATED PATENT APPLICATION

This application claims the benefit of priority to the U.S. Provisional Patent Application Ser. No. 63/595,342, filed on Nov. 2, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a measurement system, and more particularly to an X-ray measurement system with high signal resolution.

### BACKGROUND OF THE DISCLOSURE

In today's semiconductor manufacturing industry, as component sizes continue to shrink and structural complexity increases, inspection technologies are facing unprecedented challenges.” Modern semiconductor structures, such as gate-all-around (GAA) and fin field-effect transistors (FinFET), have complex three-dimensional structures that require high-precision detection technology to ensure process stability and component reliability.

However, traditional optical inspection technologies are unable to meet these demands. Therefore, X-ray measurement technology, which is a non-destructive measurement method, leverages the high energy and short wavelength characteristics of X-rays to achieve extremely high penetration capability and spatial resolution. Through the years, X-ray measurement has evolved multiple advanced techniques for collecting high-quality signals to discern the three-dimensional microstructure of samples.

However, this technology still has its drawbacks. The most significant issue is the low signal intensity, resulting in poor resolution. To overcome this shortcoming, it is necessary to have a longer signal collection time to increase the signal-to-noise ratio, a sufficiently stable X-ray light source, or a higher sensitivity detector. However, these methods will lead to an increase in equipment or time costs.

### SUMMARY OF THE DISCLOSURE

In response to the above-referenced technical inadequacies, the present disclosure provides an X-ray measurement system with high signal resolution for enhancing the reception intensity of high-order X-ray signals, thereby improving overall signal resolution.

In order to solve the above-mentioned problems, one of the technical aspects adopted by the present disclosure is to provide an X-ray measurement system with high signal resolution, and the X-ray measurement system includes an X-ray generator, an X-ray optical element group, a multi-dimensional X-ray detector and a processing device. The X-ray generator is configured to generate an incident X-ray beam. The X-ray optical element group is configured to guide the incident X-ray beam to a to-be-measured sample. The multi-dimensional X-ray detector is configured to receive a measurement X-ray beam generated by irradiating the incident X-ray beam on the to-be-measured sample. The multi-dimensional X-ray detector includes an insulating layer, a plurality of first electrode layers and a photodiode layer disposed on the insulating layer, an X-ray conversion material layer disposed on the photodiode layer and made of amorphous selenium, and a second electrode layer disposed on the X-ray conversion material layer. The processing device is connected to the multi-dimensional X-ray detector, and is configured to collect a to-be-measured X-ray signal generated by the multi-dimensional X-ray detector that receives the measurement X-ray beam, and generate a plurality of measurement results corresponding to a plurality of structural parameters of the to-be-measured sample. The plurality of measurement results include a plurality of mode signals of different orders.

Therefore, the X-ray measurement system provided by the present disclosure can enhance conversion efficiency and signal resolution by integrating the multi-dimensional X-ray detector with direct photoreceptor materials, specifically amorphous selenium. Through theoretical calculations, signal-to-noise ratio analysis, and practical measurements of reflected high-order signals from a sample with a multi-dimensional grating structure at the soft X-ray wavelength reveal that, under identical material thickness and X-ray source energy, conversion efficiency can be boosted by about 1.5 times compared to the existing X-ray detector, and the signal resolution can be enhanced by approximately 48.76%.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of an X-ray measurement system with high signal resolution according to one embodiment of the present disclosure;

FIG. 2 is a cross-sectional view of a multi-dimensional X-ray detector according to one embodiment of the present disclosure;

FIG. 3 shows a high-order signal measurement results obtained by measuring a to-be-measured sample with one-dimensional grating using an X-ray detector with a silicon material layer, and a simulation result thereof according to one embodiment of present disclosure;

FIG. 4 is a relational graph presenting an actual analysis of the relationship between SNR and the intensity of reflected or scattered signals according to one embodiment of the present disclosure; and

FIG. 5 is a simulation scatter diagram comparing effects of an amorphous selenium material layer and a silicon material layer on the SNR according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

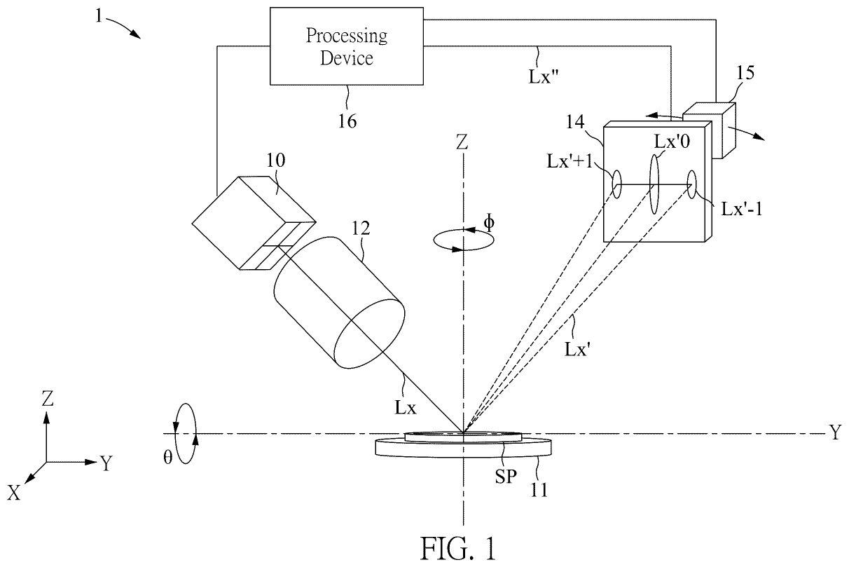

FIG. 1 is a schematic diagram of an X-ray measurement system with high signal resolution according to one embodiment of the present disclosure. Referring to FIG. 1, one embodiment of the present disclosure provides an X-ray measurement system 1 with high signal resolution, and the X-ray measurement system 1 includes an X-ray generator 10, an X-ray optical element group 12, a multi-dimensional X-ray detector 14 and a processing device 16. The X-ray generator 10 can include an X-ray tube, in which an electron beam emitter and a target material are disposed. The target material can be struck by an accelerated electron beam to generate an incident X-ray beam Lx. In addition, by selecting different target materials, such as copper (Cu), iron (Fe), molybdenum (Mo), aluminum (Al), or magnesium (Mg), it is possible to generate measurement X-ray beams Lx with different energies or different wavelengths (or frequencies).

The X-ray optical element group 12 is configured to guide the incident X-ray beam Lx to the to-be-measured sample SP. The to-be-measured sample SP can be, for example, a one-dimensional grating, a two-dimensional grating, a gate-all around and complementary field effect transistor (GAA-FET) structure, a fin field effect transistor (FinFET) structure, or a three-dimensional NAND flash memory with a high aspect ratio structure repeatedly stacked and interconnected in a vertical direction.

The to-be-measured sample SP can be placed on a multi-axis sample stage 11, which is, for example, a multi-axis movable stage, such as a three-axis tilting platform or a ball-and-socket tilting platform, for carrying the to-be-measured sample SP. The multi-axis sample stage 11 can be provided with a stage moving mechanism and a stage rotating mechanism. The stage moving mechanism can, for example, include stepping motors corresponding to three axes, for moving the to-be-measured sample SP along one or more of an X-axis, a Y-axis, and a Z-axis. By controlling the stepping motor of each axis, the to-be-measured sample SP can be accurately moved to different positions. Taking a ball-and-socket tilting platform as an example, the stage rotating mechanism can be a ball-and-socket joint connected to a platform, which can rotate the to-be-measured sample SP around one or more of the X-axis, the Y-axis and the Z-axis. In detail, a rotation mechanism of the multi-axis sample stage 11 can include controlling an azimuth angle θ of the rotation around the Y axis and an azimuth angle Φ of the rotation around the Z axis, thereby achieving a full-scale scan of the to-be-measured sample SP.

The X-ray optical element group 12 can include one or more X-ray optical elements. For example, the X-ray optical element group 12 can include an X-ray lens group, an X-ray slit, and an X-ray optical collimator sequentially disposed between the X-ray generator 10 and the to-be-measured sample SP. The X-ray lens group can have a multi-layer film structure to focus the incident X-ray beam Lx horizontally and vertically; the X-ray slit can be used to control a luminous flux of the incident X-ray beam Lx incident onto the to-be-measured sample SP while being used to control a vertical divergence angle of the incident X-ray beam Lx. The incident X-ray beam Lx can be, for example, a beam having a wavelength range greater than 0.1 nm, and can include a hard X-ray beam, a soft X-ray beam, or a gamma ray beam.

When the incident X-ray beam Lx is irradiated onto the to-be-measured sample SP, a measurement X-ray beam Lx′ will be generated due to reflection, diffraction, scattering or penetration depending on the incident angle. By setting the multidimensional X-ray detector 14 at an appropriate position, it can be used to receive the measurement X-ray beam Lx′ generated by reflection, diffraction, scattering or penetration. The multi-dimensional X-ray detector 14 can be a high spatial resolution detector of more than two dimensions, and can receive the measurement X-ray beam Lx′ having an energy greater than 1 keV. Taking a one-dimensional grating structure as an example, the to-be-measured sample SP can be moved and rotated in multi-axis manner through the multi-axis sample stage 11. Therefore, after the incident X-ray beam Lx hits the to-be-measured sample SP, signals can be collected through reflection or transmission. The multi-dimensional X-ray detector 14 can be used as a signal collection terminal. The reflected or transmitted measured X-ray beam Lx′ produces zero-order signal Lx′0, and high-order signals, including a positive first-order signal Lx′+1 and a negative first-order signal Lx′−1, respectively, due to different structures of the to-be-measured sample SP.

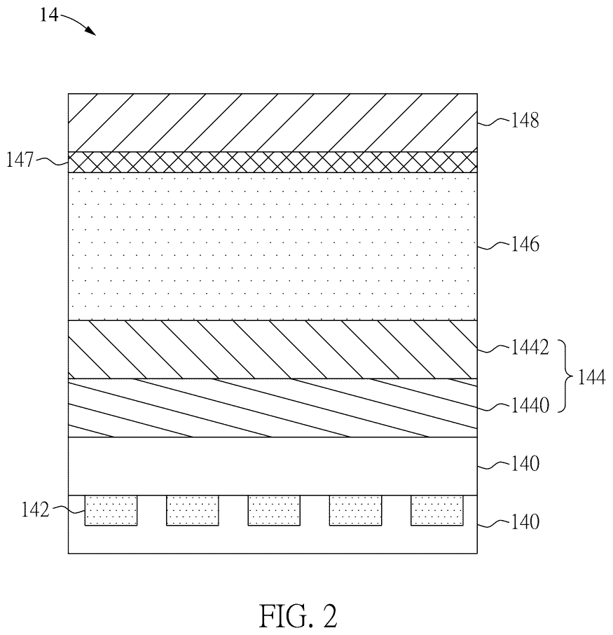

FIG. 2 is a cross-sectional view of a multi-dimensional X-ray detector according to one embodiment of the present disclosure. Referring to FIG. 2, the multi-dimensional X-ray detector 14 can include an insulating layer 140, a plurality of first electrode layers 142 and a photodiode layer 144 disposed on the insulating layer 140, an X-ray conversion material layer 146 disposed on the photodiode layer 144, and a second electrode layer 148 disposed on the X-ray conversion material layer 146. The X-ray conversion material layer 146 is made of amorphous selenium and is a direct X-ray conversion material layer that can directly convert received photons of the measurement X-ray beam Lx′ into electron-hole pairs. Preferably, a thickness of the X-ray conversion material layer 146 can be greater than 50 μm to ensure sufficient absorption of photons.

In detail, the multi-dimensional X-ray detector 14 provided by the embodiment of the present disclosure utilize a design of a back-emitting multi-dimensional detector, and the second electrode layer 148 is a negative bias electrode layer. The photodiode layer 144 can include a first semiconductor layer 1440 and a second semiconductor layer 1442. The first semiconductor layer 1440 is disposed on the insulating layer 140 and is a first conductivity type, and the second semiconductor layer 1442 is disposed on the first semiconductor layer 1440 and is a second conductivity type. In some embodiments, the first semiconductor layer 1440 and the second semiconductor layer 1442 are respectively an N-type crystalline silicon layer and a P-type crystalline silicon layer to form a photodiode. The second electrode layer 148 can be made of a conductive metal, such as Pt, Cr or Au, or other appropriate electrode materials.

In addition, the multi-dimensional X-ray detector 14 further includes an electron blocking layer 147 disposed between the second electrode layer 148 and the X-ray conversion material layer 146. When the measurement X-ray beam Lx′ passes through the X-ray conversion material 146, the measurement X-ray beam Lx′ is directly converted into electrons within the X-ray conversion material layer 146 through the photoelectric effect. These electrons are then transmitted, while the negative bias electrode layer (second electrode layer 148) and the electron blocking layer 147 at a surface are used to prevent the electrons from moving towards the second electrode layer 148. The electron blocking layer 147 can be, for example, amorphous selenium doped with arsenic, but the present disclosure is not limited thereto.

When electrons are transferred to the P-type silicon crystal layer (the second semiconductor layer 1440), due to different concentrations of electron carriers, a depletion region is formed in the P-type crystalline silicon layer and the N-type crystalline silicon layer, and are diffused to the first electrode layer 142. The plurality of first electrode layers 142 can be arranged in an array, for example, and each of the first electrode layers 142 can be a polysilicon electrode layer, for example. A portion of the insulating layer 140 can be firstly formed on a lower surface of the second semiconductor layer 1440, then a plurality of first electrode layers 142 can be formed, and then another portion of the insulating layer 140 can be formed to cover all of the first electrode layers 142. Two polysilicon electrode layers are also separated by the insulating layer 140, thereby protecting the first electrode layer 142 and preventing current leakage. The insulating layer 140 can be made of silicon dioxide, for example.

In addition, in the multi-dimensional X-ray detector 14 of the embodiment of the present disclosure, the measurement X-ray beam Lx′ can be directly converted into an electronic signal (a to-be-measured X-ray signal Lx″) through the amorphous selenium material layer to obtain multi-order mode signals in the diffraction pattern. In addition, the processing device 16 can employ a vertical integration mode to process the received to-be-measured signal Lx″ of the multi-dimensional X-ray detector 14, such that the mode signals respectively at specific angles corresponding to specific orders can be captured as measurement results.

The processing device 16 can be, for example, a computer system including a processor and a memory, and can be configured to execute stored instruction sets or program codes to control the X-ray generator 10 to generate an incident X-ray beam Lx. The processing device 16 can further perform subsequent analysis on the to-be-measured X-ray signal Lx′ generated by the multi-dimensional X-ray detector 14. In addition, during the measurement, the processing device 16 can control the multi-axis sample stage 11 to move and/or rotate, such that the X-ray detector 14 receives multiple measurement X-rays Lx′ generated at multiple X-ray measurement angles, and generates multiple to-be-measured X-ray signals Lx″ after signal amplification processing. After receiving these to-be-measured X-ray signals Lx “, the processing device 16 can further generate multiple records of X-ray spectrum information corresponding to the to-be-measured X-ray signals Lx”. These records of the X-ray spectrum information actually correspond to structural parameters of the to-be-measured sample SP, and can be directly output as the measurement results of the to-be-measured sample SP, or the records of the X-ray spectrum information can be further fitted to obtain the structural parameters of the to-be-measured sample SP as the measurement results.

In the embodiment of FIG. 1, the multi-dimensional X-ray detector 14 is further disposed on an X-ray rotating mechanism 15, such that the multi-dimensional X-ray detector 14 can be rotated around the to-be-measured sample SP (e.g., with the Z axis as an axis). The X-ray rotation mechanism 15 can be, for example, a robot arm, and is controlled and rotated by the processing device 16 to move the multi-dimensional X-ray detector 14 to a predetermined angle range and obtain a plurality of diffraction patterns, which can include, for example, a zero-order mode signal, first-order mode signals, and second-order mode signals.

Generally, the zero-order, first-order, and second-order mode signals obtained from the to-be-measured sample SP, under different structural parameters (e.g., varying line widths), will exhibit variations corresponding to changes in these structural parameters. Within a specific angle range, high-order mode signals (first-order and second-order) exhibit more pronounced reflectance changes compared to low-order mode signals (zero-order) under identical line width variations, which indicates that the high-order mode signals are highly sensitive to structural variations (e.g., line width) at certain angles. Based on the aforementioned phenomena, enhancing the signal quality of the high-order mode signals will significantly improve the accuracy of measurement results.

The following analysis examines the performance of the multi-dimensional X-ray detector 14 used in the present disclosure from the perspective of absorption efficiency. An absorption coefficient is a parameter that measures the ability of a material to absorb and attenuate X-rays. Reference is made to the following equation (1):

$$I = {I}_{0} {e}^{- μ x} . \qquad equation ( 1 )$$

In equation (1), I is an intensity of the measurement X-ray beam Lx′ passing through a material, I₀ is an intensity of the incident X-ray beam Lx, μ is a linear attenuation coefficient of the material, x is a material thickness, and an absorption efficiency η (attenuation efficiency) is a proportion of incident X-rays absorbed at a specific thickness. Specifically, equation (1) can be simplified with the absorption coefficient to obtain the following equation (2):

$$η = 1 - \frac{I ( x )}{{I}_{0}} = 1 - {e}^{μ x} . \qquad equation ( 2 )$$

In the embodiment of the present disclosure, the X-ray conversion material layer 146 made of amorphous selenium is compared to a silicon material layer with the same thickness. Given that I₀ is approximately 1.487 keV (soft X-ray energy), the linear attenuation coefficient μSe of the X-ray conversion material layer 146 is 2.688 μm⁻¹, while the linear attenuation coefficient μSi of the silicon material layer is 0.127 μm⁻¹. Substituting these values into the above equation (2) reveals that, at the same thickness, the absorption efficiency of the amorphous selenium material layer is about 21.16 times higher than that of the silicon material layer.

On the other hand, signal conversion efficiency must take into account both material absorption efficiency and its conversion efficiency. Therefore, in the multi-dimensional X-ray detector 14, X-rays or other radiation must be converted into electron-hole pairs (a quantity thereof is denoted by N). Once the electrons are collected, the flowing electrons form current pulses, which can be further converted into the measurement signal Lx″ through a signal processing circuit (e.g., an amplifier). Hence, the quantity of the electron-hole pairs is directly proportional to the actual signal intensity, as shown in the following equation (3):

$$N = \frac{E}{w} . \qquad equation ( 3 )$$

where E is an X-ray energy, w is an average energy (eV) required to generate electron-hole pairs, an average energy WSe required for the X-ray conversion material layer 146 to generate electron-hole pairs is 50, and an average energy WSi required for the silicon material layer to generate electron-hole pairs is 3.6. Substituting equation (2) into equation (3) for simplification, the following equation (4) can be obtained:

$${E}_{absorbed} = {E}_{0} \times η + {E}_{0} \times ( 1 - {e}^{- μ x} ) . \qquad equation ( 4 )$$

Where E_{absorbed} is the X-ray energy absorbed by the X-ray conversion material layer 146, and E, is the X-ray energy of the incident X-ray beam Lx.

Next, comparing quantities of electron-hole pairs generated by the two materials, where the quantity generated by the X-ray conversion material layer 146 is denoted as NSe, and the quantity generated by the silicon material layer is denoted as NSi. After simplification, equation (5) can be obtained:

$$\frac{NSe}{NSi} = \frac{{E}_{0} \times ( 1 - {e}^{- {μ}_{Se} x} ) / WSe}{{E}_{0} \times ( 1 - {e}^{- {μ}_{Si} x} ) / WSi} . \qquad equation ( 5 )$$

By incorporating the previously mentioned linear attenuation coefficients (μ_{Se} and μ_{Si}) and the average energy required to generate an electron-hole pair (WSe and WSi) for amorphous selenium and silicon materials respectively at 1.487 keV, calculations indicate that the X-ray conversion efficiency of amorphous selenium is 1.5 times higher than that of silicon at the same thickness. Therefore, under the same thickness design and with soft X-ray incidence (energy of 1.487 keV), the signal intensity collected by the multi-dimensional X-ray detector can theoretically be increased by 50% compared to conventional silicon materials, thereby enhancing measurement resolution.

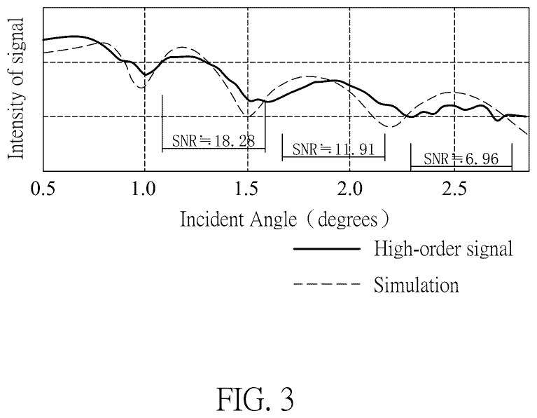

Referring to FIG. 3, FIG. 3 shows a high-order signal measurement results obtained by measuring a to-be-measured sample with one-dimensional grating using an X-ray detector with a silicon material layer, and a simulation result thereof according to one embodiment of present disclosure. To evaluate reasonable signal quality conditions, the present embodiment uses a 50 nm thick, 139 m pitch silicon dioxide one-dimensional grating as the to-be-measured sample SP, and compares the high-order scattering signals obtained with the X-ray detector using a silicon material layer against simulation results that disregard the SNR ratio. In FIG. 3, the horizontal axis represents the angle, and the vertical axis shows the received signal intensity. The dashed line indicates high-order signals obtained under the same one-dimensional grating structure used in both simulation and experiment. The results show that for a single-layer 50 nm thick silicon dioxide one-dimensional grating, the high-order scattering spectrum exhibits regular, periodic signals with a period of 0.6 degrees, irrespective of the SNR.

On the other hand, the solid line represents the actual measurement results while assessing the signal-to-noise ratio (SNR). Analysis of the actual measurement data shows that the SNR of the peaks of the first and second fringes, within a period of 0.6 degree, are both greater than 10, whereas the SNR of the third fringe peak is 6.96. When the SNR is less than 10, the fringe resolution significantly decreases. Therefore, for subsequent analysis, the SNR should be greater than 10 to ensure good signal resolution.

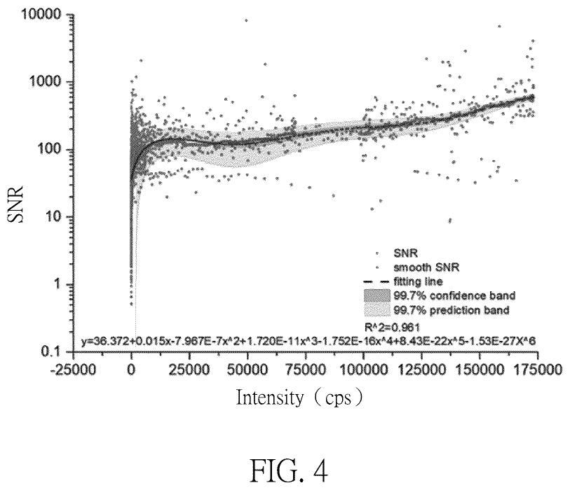

FIG. 4 is a relational graph presenting an actual analysis of the relationship between SNR and the intensity of reflected or scattered signals according to one embodiment of the present disclosure. The detector used to collect signals in this relational graph primarily consists of silicon materials. A nonlinear fitting analysis was conducted within a 99.7% confidence interval, revealing that the SNR and X-ray signal intensity have a nonlinear exponential polynomial relationship. The fitted equation is obtained as follows:

$$y = - 1.53 * {10}^{- 27} {x}^{6} + 8 * {10}^{- 43} {x}^{5} - 1.752 * {10}^{- 16} {x}^{4} + 1.72 * {10}^{- 11} {x}^{3} - 7.967 * {10}^{- 7} {x}^{2} + 0.015 x + 36.372 .$$

Where R²=0.961, which is credible. The above results indicate that the intensity of X-ray signal, whether reflected, scattered, or transmitted, affects their SNR after interacting with the structure of the measured sample. Thus, enhancing the intensity of the received X-ray signals can effectively improve the signal resolution during measurements.

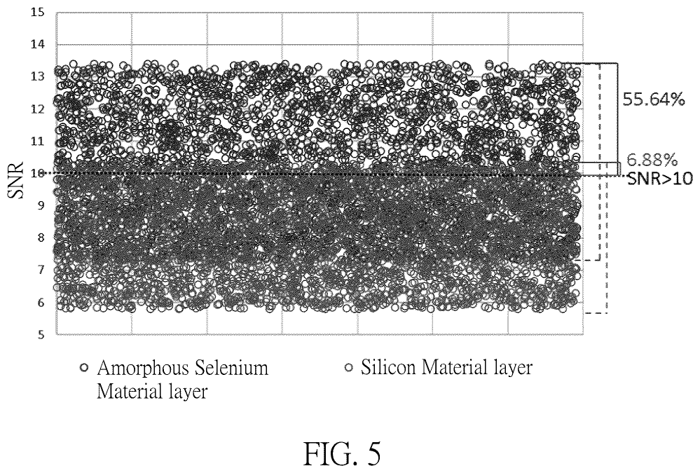

FIG. 5 is a simulation scatter diagram comparing effects of an amorphous selenium material layer and a silicon material layer on the SNR according to one embodiment of the present disclosure. From the fitted relationship y=−1.53*10⁻²⁷x⁶+8*10⁻⁴³x⁵−1.752*10⁻¹⁶x⁴+1.72*10⁻¹¹x³−7.967*10⁻⁷x²+0.015x+36.372 obtained in FIG. 5, it is evident that the signal intensity received by the X-ray receiver needs to be greater than 200 counts per second (cps) for the SNR to exceed 10. Therefore, when utilizing a silicon-based X-ray detector and applying the specified conditions in a random simulation with over 3,500 data points, only 6.88% of the SNR values exceeded 10. This implies that merely 6.88% of the signals possess a higher resolution.

Conversely, when utilizing the amorphous selenium material layer as the X-ray conversion material layer 146 in the multi-dimensional X-ray detector 14 of the present disclosure, theoretical calculations indicate that the conversion efficiency is approximately 1.5 times greater than that of the silicon material layer. An SNR simulation scatter plot, created using the same method, is displayed in FIG. 5. Simulation results show that, out of the same 3,500+ random data points, 55.64% of the SNR values exceed 10. In other words, using the amorphous selenium material layer as the X-ray conversion layer 146 in the multi-dimensional X-ray detector 14 can enhance measurement resolution by approximately 48.76%.

### Beneficial Effects of the Embodiments

In conclusion, the X-ray measurement system provided by the present disclosure can enhance conversion efficiency and signal resolution by integrating the multi-dimensional X-ray detector with direct photoreceptor materials, specifically amorphous selenium. Through theoretical calculations, signal-to-noise ratio analysis, and practical measurements of reflected high-order signals from a sample with a multi-dimensional grating structure at the soft X-ray wavelength reveal that, under identical material thickness and X-ray source energy, conversion efficiency can be boosted by about 1.5 times compared to the existing X-ray detector, and the signal resolution can be enhanced by approximately 48.76%.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An X-ray measurement system with high signal resolution, the X-ray measurement system comprising:
an X-ray generator configured to generate an incident X-ray beam;
an X-ray optical element group configured to guide the incident X-ray beam to a to-be-measured sample;
a multi-dimensional X-ray detector configured to receive a measurement X-ray beam generated by irradiating the incident X-ray beam on the to-be-measured sample, wherein the multi-dimensional X-ray detector includes:
an insulating layer;
a plurality of first electrode layers disposed on the insulating layer;
a photodiode layer disposed on the insulating layer;
an X-ray conversion material layer disposed on the photodiode layer, wherein the X-ray conversion material layer is made of amorphous selenium; and
a second electrode layer disposed on the X-ray conversion material layer; and
a processing device connected to the multi-dimensional X-ray detector, wherein the processing device is configured to collect a to-be-measured X-ray signal generated by the multi-dimensional X-ray detector that receives the measurement X-ray beam, and generate a plurality of measurement results corresponding to a plurality of structural parameters of the to-be-measured sample, wherein the plurality of measurement results include a plurality of mode signals of different orders.

2. The X-ray measurement system according to claim 1, wherein the photodiode layer includes:
a first semiconductor layer disposed on the insulating layer and being a first conductivity type; and
a second semiconductor layer disposed on the first semiconductor layer and being a second conductivity type.

3. The X-ray measurement system according to claim 2, wherein the first semiconductor layer and the second semiconductor layer are an N-type crystalline silicon layer and a P-type crystalline silicon layer, respectively.

4. The X-ray measurement system according to claim 2, wherein the multi-dimensional X-ray detector further includes an electron blocking layer disposed between the second electrode layer and the X-ray conversion material layer.

5. The X-ray measurement system according to claim 4, wherein a thickness of the X-ray conversion material layer is greater than 50 μm.

6. The X-ray measurement system according to claim 4, wherein the plurality of first electrode layers are a plurality of polysilicon electrode layers.

7. The X-ray measurement system according to claim 1, wherein when the processing device is configured to collect the to-be-measured X-ray signal and generate the plurality of measurement results corresponding to the to-be-measured sample, the processing device is further configured to:
obtain a plurality of signal patterns within a predetermined angle range through the multi-dimensional X-ray detector; and
extract the plurality of mode signals corresponding to different orders for each of the plurality of signal patterns.

8. The X-ray measurement system according to claim 7, further comprising a multi-axis sample stage for carrying the to-be-measured sample.

9. The X-ray measurement system according to claim 8, wherein the multi-axis sample stage has a stage moving mechanism and a stage rotating mechanism, the stage moving mechanism is configured to move the to-be-measured sample along one or more of a first axis, a second axis and a third axis, and the stage rotating mechanism is configured to rotate the to-be-measured sample around one or more of the first axis, the second axis and the third axis.

10. The X-ray measurement system according to claim 9, wherein the multi-dimensional X-ray detector is disposed on an X-ray rotating mechanism, such that the multi-dimensional X-ray detector rotates around the to-be-measured sample;
wherein the processing device is further configured to control the X-ray rotating mechanism to rotate, such that the multi-dimensional X-ray detector obtains a plurality of diffraction patterns within the predetermined angle range.
